(19) United States
(12) Patent Application Publication
(10) Pub. No.: US 2019/0057606 A1
(43) Pub. Date: Feb. 21, 2019

(54) WARNING TO VULNERABLE USERS IN DANGEROUS SITUATION

(71) Applicant: Continental Automotive Systems, Inc., Auburn Hills, MI (US)

(72) Inventor: Jeffrey Skvarce, Clarkston, MI (US)

(73) Assignee: Continental Automotive Systems, Inc., Auburn Hills, MI (US)

(21) Appl. No.: 16/103,618

(22) Filed: Aug. 14, 2018

Related U.S. Application Data
(60) Provisional application No. 62/545,687, filed on Aug. 15, 2017.

(51) Int. Cl. G08G 1/16

(52) U.S. Cl. CPC G08G 1/166

(57) ABSTRACT

A warning system which includes at least one sensor operable for detecting one or more objects in a detection area of a high-traffic area, at least one communication device in electrical communication with the sensor, and at least one warning device in electrical communication with the communication device. At least one warning alert is produced by the warning device, and the communication device commands the warning device to produce the warning alert when the sensor detects a potential collision between at least one virtual road user and at least one vehicle. The warning alert may be one of several types of alerts, such as, but not limited to, an audible sound warning, a visual warning, or a haptic warning. The warning alert may be a plurality of warning alerts, such that warning device is operable for producing more than one of the plurality of warning alerts simultaneously.

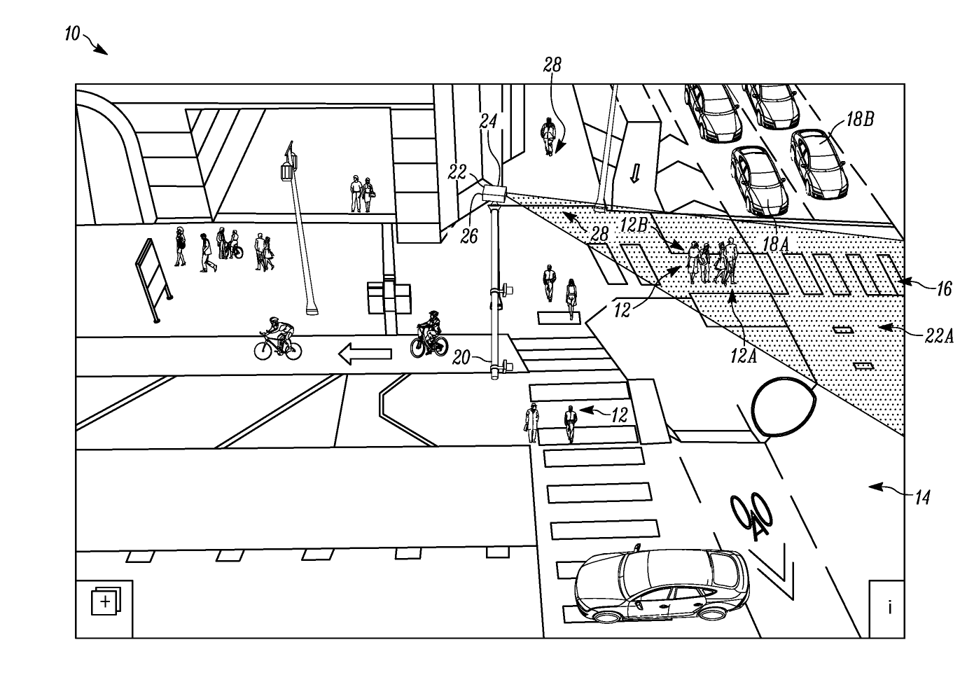

### FIELD OF THE INVENTION

The invention relates generally to a system for warning vulnerable road users of a potential collision with oncoming vehicles, such that the vulnerable road user may take necessary steps to ensure that a collision is avoided.

### BACKGROUND OF THE INVENTION

Currently, there are many types of systems in place, which are part of a vehicle, to make a driver of the vehicle aware of potential dangers with regard to collisions with pedestrians, other vehicles, and other objects along the side of a road. However, pedestrians currently do not have any type of warning system in place to provide an alert that a potential collision may occur if steps are not taken to avoid the collision. Intersections and cross-walks for pedestrians in densely populated urban areas present one of the most dangerous areas where accidents may occur, such as an automobile hitting a pedestrian. Additionally, pedestrians are also distracted by cell phones, tablet computers, billboards, other pedestrians, and the like, which may limit the ability of the pedestrian to be fully aware of any dangers resulting from vehicles that may be driving unsafely.

Accordingly, there exists a need for a warning system, which may be part of the infrastructure of an urban environment, and is used to alert various pedestrians of potential collisions with vehicles.

### SUMMARY OF THE INVENTION

Using object detection in potentially dangerous areas (such as road crossings, intersections, streets with high pedestrian or cyclist activity) and existing vulnerable road user EBA algorithms, a potential collision may be foreseen and instead of only the car responding with EBA type system and alerting the driver or automatically applying the brakes, an audio, visual, or haptic alert could also be sent from the smart city infrastructure to warn the vulnerable road user (VRU) of a potential collision so they may become aware of the situation and take the appropriate measures to prevent a collision. The pedestrians may be listening to music, texting, or may be deaf. These audio and/or visual signals and/or haptic warnings may help warn them of a potentially dangerous encounter such that they may take necessary precautions.

Since EBA systems have sensors that may accurately determine the location, speed, and direction of objects (pedestrians, bicyclists, etc), and may be equipped with V2x technologies and communicate with the smart city infrastructures, key information may be shared to allow for localized warnings in pedestrian/cyclist areas. Alternatively, if smart city sensors and warnings (which are part of the city infrastructure) are not available, it is possible (using V2x messaging) for the vehicle itself to warn the nearby vulnerable road users. This would be done using smart headlights or a sound system that may be directed at the VRU, or in the surrounding vicinity.

It is also possible to have cell phones equipped with DSRC, 5 g or similar technology warn the VRU directly from the smart phone device with haptic, audio, visual alerts.

In one embodiment, the present invention is a warning system which includes at least one sensor operable for detecting one or more objects in a detection area, at least one communication device in electrical communication with the sensor, and at least one warning device in electrical communication with the communication device. At least one warning alert is produced by the warning device, and the communication device commands the warning device to produce the warning alert when the sensor detects a potential collision between at least one virtual road user and at least one vehicle.

The warning alert may be one of several types of alerts, such as, but not limited to an audible sound warning, a visual warning, and a haptic warning. In one embodiment, the warning alert may be a plurality of warning alerts, such that warning device is operable for producing more than one of the plurality of warning alerts simultaneously.

The sensor may be any type of sensor able to detect one or more objects in the detection area, such as, but not limited to, long-range radar, short-range radar, LIDAR (Light Imaging, Detection, and Ranging), LADAR (Laser Imaging, Detection, and Ranging), camera, ultrasound, or sonar.

The warning system is integrated into an area such that at least one component of the at least one warning system is part of an infrastructure component.

The vehicle incudes at least one turn signal, at least one headlight, and a horn device. The communication device is in communication with the vehicle such that the warning alert is achieved by the activation of one or more of the headlight, turn signal, and the horn device to alert the virtual road user of the location of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The FIGURE is a perspective view of a traffic intersection having a warning system being part of an infrastructure component, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

An example of a system for warning vulnerable road users (VRU) is shown in the FIGURE generally at 10. There are also several vulnerable road users (VRUs), shown generally at 12, travelling near an intersection, shown generally at 14. More specifically, there are two vulnerable road users 12A,12B attempting to cross the intersection 14 at a cross-walk, shown generally at 16. A first vehicle 18A is stopped near the cross-walk 14, and a second vehicle 18B is moving towards the intersection 16 in a direction that is perpendicular to the direction of travel of each of the VRUs 12A,12B.

The warning system 10 includes some type of infrastructure component, which in this embodiment is a post, shown generally at 20, having at least one sensor 22, at least one communication device 24, and at least one warning device 26. While in this embodiment, the infrastructure component is the post 20, it is within the scope of the invention that the warning system 10 may include any other type of infrastructure component, such as a building, bridge, parking structure, support structure, or the like. In this embodiment, the sensor 22, communication device 24, and the warning device 26 are integrated into a single component, but it is within the scope of the invention that the sensor 22, communication device 24, and the warning device 26 may be separate components in different locations. The sensor 22 in this embodiment is able to detect objects in a detection area, shown generally at 22A. In one embodiment, the sensor 22 is a long-range radar sensor 22, but it is within the scope of the invention that other types of sensors maybe used, such as, but not limited to LIDAR (Light Imaging, Detection, and Ranging), LADAR (Laser Imaging, Detection, and Ranging), other types of radar, a camera, ultrasound, or sonar.

In the example shown in the FIGURE, the first vehicle 18A is blocking the view of each VRU 12A,12B crossing the intersection 14, such that each VRU 12A,12B is unable to see the second vehicle 18B approaching the intersection 14. If each VRU 12A,12B continues to walk through the intersection 14 unaware of the path of travel of the second vehicle 18B, the second vehicle 18B may collide with and seriously injure or kill one of the VRUs 12A,12B. However, the system 10 of the present invention includes the sensor 22 which sends a signal to the communication device 24 providing an indication of the location, speed, and direction of any object (either pedestrian or vehicle) in the detection area 22A.

In the FIGURE, the sensor 22 is able to detect the location, as well as speed and direction of each vehicle 18A,18B, and the location, speed, and direction of each VRU 12A,12B. While there are two VRUs 12A,12B which are walking in the example shown in the FIGURE, it is within the scope of the invention that the sensor 22 is able to detect if each VRU 12 is walking, traveling by bicycle, scooter, skateboard, rollerblades, or the like. If there is a potential risk of collision between the second vehicle 18B and one of the VRU's 12A,12B in the detection area 22A detected by the sensor 22, a signal is sent to the communication device 24, such that the communication device 24 sends a signal to the warning device 26 to alert each VRU 12A,12B that there is a potential danger of collision with the vehicle 18B. The warning device 26 then sends out a warning alert, an example of which is indicated generally at 28, indicating to each VRU 12A,12B that there is a potential danger when entering the cross-walk 16. This allows each VRU 12A,12B to take measures to avoid entering the cross-walk 16 before it is safe to do so.

The warning device 26 may be equipped to send out different types of warning alerts 28, such as, but not limited to, an audible sound warning, a visual warning, or a haptic warning. The warning alert 28 may accommodate various any type of VRU 12 traveling under various conditions. For example the VRU 12 may be deaf, listening to headphones, or have limited hearing ability due to some other condition, and require the warning alert 28 to a visual or haptic warning. The visual warning may be an illuminated sign, a flashing light or combination of flashing lights, or some other type of visual warning. The haptic warning may be force air pressure directed towards each VRU 12A,12B, or one or more areas of the cement that vibrate that each VRU 12A,12B is walking across, prior to entering the cross-walk 16.

In one embodiment, the communication device 24 is a dedicated short range communication (DSRC) device 24, but it is within the scope of the invention that other types of communication devices maybe used.

In an alternate embodiment, the warning device 26 may instead be a signal provided by one of the vehicles 18A,18B. The warning device may be illumination of one or more of, or a combination of, the headlights and turn signals of one or both of the vehicles 18A,18B, or the activation of the horn of one or both of the vehicles 18A,18B, either alone or in combination with one or more of the lights of one or both of the vehicles 18A,18B.

In another alternate embodiment, the warning device 26 may be one or more cell phones, tablets, or other computing device capable of communication with the communication device 24, where the computing device is used by one of the VRUs 12A,12B. The warning device 26 may provide a visual alert, such as a warning on a screen of the computing device, an audible sound produced by the computing device, or a haptic warning, where the computing device vibrates to provide one of the VRUs 12A,12B that there is a danger of a collision with one of the vehicles 18A,18B.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a warning system, including:
at least one sensor operable for detecting one or more objects in a detection area;
at least one communication device in electrical communication with the at least one sensor;
at least one warning device in electrical communication with the communication device;
at least one warning alert produced by the at least one warning device;
wherein the communication device commands the at least one warning device to produce the at least one warning alert when the at least one sensor detects a potential collision between at least one virtual road user and at least one vehicle.

2. The apparatus of claim 1, the at least one warning alert being one selected from the group consisting of an audible sound warning, a visual warning, and a haptic warning.

3. The apparatus of claim 1, the at least one warning alert further comprising a plurality of warning alerts, wherein the at least one warning device is operable for producing more than one of the plurality of warning alerts simultaneously.

4. The apparatus of claim 1, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.

5. The apparatus of claim 1, wherein at least one component of the at least one warning system is part of an infrastructure component.

6. The apparatus of claim 1, further comprising:
a vehicle;
at least one turn signal being part of the vehicle;
at least one headlight being part of the vehicle; and
a horn device being part of the vehicle;
wherein the at least one communication device is in communication with the vehicle such that the at least one warning alert is achieved by the activation of one or more of the at least one headlight, at least one turn signal, and the horn to alert the at least one virtual road user of the location of the at least one vehicle.

7. A warning system for alerting at least one virtual road user of potential danger, comprising:
at least one sensor operable for detecting one or more virtual road users in a detection area, and one or more vehicles in the detection area;
at least one communication device in electrical communication with the at least one sensor;
at least one warning device in electrical communication with the communication device;
at least one warning alert produced by the at least one warning device;
an infrastructure component, the at least one sensor and the at least one communication device connected to the at least one infrastructure component;
an intersection, the infrastructure component located near the intersection;
wherein the communication device commands the at least one warning device to produce the at least one warning alert when the at least one sensor detects a potential collision between the one or more virtual road users and the one or more vehicles.

8. The warning system of claim 7, wherein the at least one warning device is connected to the infrastructure component.

9. The warning system of claim 7, wherein the at least one warning device is one or more of the components on one of the one or more vehicles.

10. The warning system of claim 9, each of the one or more vehicles further comprising:
at least one turn signal;
at least one headlight; and
a horn device;
wherein the at least one communication device is in communication with the one or more vehicles such that the at least one warning alert is achieved by the activation of one or more of the at least one headlight, at least one turn signal, and the horn to alert the one or more virtual road users of the location and direction of movement of the one or more vehicles.

11. The warning system of claim 7, the at least one warning alert further comprising a plurality of warning alerts, wherein the at least one warning device is operable for producing more than one of the plurality of warning alerts simultaneously.

12. The warning system of claim 7, the at least one warning alert being one selected from the group consisting of an audible sound warning, a visual warning, and a haptic warning.

13. The warning system of claim 7, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.
